(19) United States
(12) Patent Application Publication
(10) Pub. No.: US 2004/0100560 A1
(43) Pub. Date: May 27, 2004

(54) Tracking digital zoom in a digital video camera

(76) Inventors: Donald J. Stavely, Windsor, CO (US); Robert P. Cozier, Fort Collins, CO (US); Amy E. Battles, Windsor, CO (US); James W. Owens, Fort Collins, CO (US); James S. Voss, Fort Collins, CO (US); Dan L. Dalton, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/302,383

(22) Filed: Nov. 22, 2002

(51) Int. Cl. H04N 5/228

(52) U.S. Cl. 348/208.1

(57) ABSTRACT

A digital video camera and method that employs a motion detection algorithm to keep the camera locked onto an image when recording digital video images, particularly when using digital zoom features of the camera. The digital video camera comprises a record button, a lens, an image sensor for receiving images viewed by the lens, a viewfinder for viewing the images received by the image sensor, a zoom control for digitally zooming the image received by the image sensor, and processing circuitry coupled to the image sensor. The motion detection algorithm extracts video frames from the sensor images, such that the resulting video image substantially tracks the scene, despite motion of the camera.

### TECHNICAL FIELD

The present invention relates generally to digital video cameras, and more specifically, to the use of motion detection to keep a digital video camera locked onto a scene when recording video with digital zoom.

### BACKGROUND

One of the biggest limitations of digital video cameras for consumers is the need to constantly aim the camera. A user may want to record an event, but may also want to be a participant in the event as well. The user thus feels removed from the activity for the entire length of the video recording. This makes using the camera a painful chore rather than a fun experience. What is needed is a way to allow the user to aim the camera at a subject to start the video recording, but then to return their primary attention to the event itself.

Using a tripod is one solution to the problem. Unfortunately, tripods are relatively bulky, heavy, and awkward to use in many settings.

Digital image stabilization has been used to reduce camera shaking or jitter when recording video. Digital image stabilization works by using a CCD that is somewhat larger than the area that is sampled for a video frame. Motion of the camera is detected and the boundary of the sampled image is shifted in the opposite direction to compensate for the movement of the camera. Slower motion of the camera is not compensated, allowing the user to pan the scene. Unfortunately, this still requires the user to constantly aim the camera to frame the subject being recorded.

U.S. Pat. No. 5,748,231 discloses that a “digital image stabilization device receives correlation data generated from a plurality of local motion estimation areas and adaptively decides a motion vector according to irregular image environment. To do this, statistical variables and local motion vector are generated to check reliability by checking correlation values generated from each local motion estimation area. Then, it is determined that there is irregular image data deteriorating reliability of local motion vector, by analyzing statistical variables. Here, the irregular image environment can be in an image signal with low contrast, an image signal with a moving object, an image signal with repeated motion, etc. Also, isolativity and stability are obtained by analyzing local motion vector and a weight signal is generated with a predefined rate according to a computed result. Then, the output of the weight signal is controlled, according to a result of the reliability determination signal, where if there is irregular image data, the output of weight signal is blocked. And, a field motion vector is generated by multiplying a weight signal by a corresponding local motion vector and then averaging them. Finally, an accumulated motion vector is generated by attenuating a previous accumulated motion vector and adding the attenuated previous accumulated motion vector into the field motion vector.”

U.S. Pat. No. 5,748,231 discloses an “automatic focusing device includes an image pickup device for outputting an image signal by performing photoelectric conversion of an image of an object, a band-pass filter for extracting a sharpness signal corresponding to the sharpness from among the image signal, a diaphragm for controlling the amount of light incident upon the image pickup device, and a control circuit for controlling prohibition of the drive of a focusing lens based on a change in the sharpness signal output from the band-pass filter and a change in the state of the diaphragm. It is thereby possible to exactly detect an operation, such as panning or the like, and to prevent the stop of the focusing lens at a defocused position caused by an erroneous operation by prohibiting the drive of the focusing lens when panning has been detected.”

U.S. Pat. No. 5,973,733 discloses that a “system (26) for stabilizing a video recording of a scene (20, 22, & 24) made with a video camera (34) is provided. The video recording may include video data (36) and audio (38) data. The system (26) may include source frame storage (64) for storing source video data (36) as a plurality of sequential frames. The system (26) may also include a processor (50) for detecting camera movement occurring during recording and for modifying the video data (36) to compensate for the camera movement. Additionally the system (26) may include destination frame storage (70) for storing the modified video data as plurality of sequential frames.”

U.S. Pat. No. 6,118,484 discloses an “imaging apparatus includes a sight axis detecting unit for detecting a sight axis of an observer, a driving unit for driving an objective lens system on the basis of an area detected by the sight axis detection unit, a display unit for displaying areas of a plurality of objects on the basis of an image signal of an image pick-up unit, an image pick-up unit, and an objective lens system.”

U.S. Pat. No. 6,208,377 discloses an “image-shake correcting device includes a vibration sensor for detecting a vibration of an apparatus, a correcting member for correcting a movement of an image due to a vibration, a first controlling circuit for controlling the correcting member on the basis of an output of the vibration sensor and driving the correcting member in a direction in which the movement of the image is corrected, a detecting circuit for detecting a frequency and an amplitude of the vibration from the output of the vibration sensor, and a second controlling circuit for controlling a characteristic of the first controlling circuit on the basis of an output of the detecting circuit.”

U.S. Pat. No. 6,211,912 discloses a “method for determining camera-induced scene changes in a sequence of visual information-bearing frames which constitute a single shot first determines camera-induced motion between each of a plurality of pairs frames within a single camera shot. The camera-induced motion for each of the pairs of frames is decomposed into at least a first component. The values of the first component for each of the pairs of frames are summed to form a first cumulative signal. A scene change is indicated when the first cumulative signal meets a certain decision criteria.”

U.S. Pat. No. 5,748,231 discloses that an “image stabilizer selectively adds image data from a background image to the current image to compensate for data in the current image that is missing due to a sudden shift in the current image relative to the previous images. The current image is warped into the coordinate system of the background image and then the warped current image is merged with the background image to replace any blank areas in the current image with corresponding pixel values from the background image. The image data from the background image which is to be substituted into the warped current image is subject to a low-pass filtering operation before it is merged with the warped current image. The warped current image is merged with the background image to form a modified background image which is then merged with the warped current image. The background image is, itself, warped to track camera motion in obtaining the current image before the background image is merged with the warped current image.”

U.S. Pat. No. 6,233,009 discloses that an “image-shake correcting device includes a vibration sensor for detecting a vibration of an apparatus, a correcting member for correcting a movement of an image due to a vibration, a first controlling circuit for controlling the correcting member on the basis of an output of the vibration sensor and driving the correcting member in a direction in which the movement of the image is corrected, a detecting circuit for detecting a frequency and an amplitude of the vibration from the output of the vibration sensor, and a second controlling circuit for controlling a characteristic of the first controlling circuit on the basis of an output of the detecting circuit.”

U.S. Pat. No. 6,317,114 discloses an “image stabilizing apparatus and method for a display device having a display screen, include a sensor for sensing a movement of the display device, and a movement compensation circuit, operatively coupled to the sensor, for compensating for the movement of the display device such that an image on the display screen of the display device remains substantially stationary in relation to an observer's gaze.”

U.S. Pat. No. 6,370,330 discloses an “image shake detecting device for detecting a shake of an image on an image sensing plane on the basis of a video signal output from an image sensor includes detection circuits arranged to detect image displacement in a plurality of areas set on the image sensing plane, and a control microcomputer which makes a discrimination, on the basis of information output from these detection circuits, between a movement of a camera and a solo movement of a photographed object. The device thus accurately makes compensation for an image shake by judging the state of the image on the basis of information output from these detection circuits. The image shake detecting device further includes a computing circuit arranged to compute a quantity of an image shake on the basis of a difference in detecting timing of a feature point of the image and a sensitivity control circuit arranged to change the detection sensitivity of the shake detection circuits. Further disclosed is an object tracing device to which the invented image shake detecting device is applied.”

U.S. Pat. No. 6,441,848 discloses that a “digital camera has a sensor array which removes subject motion blur by monitoring the rate at which charge is collected by the individual sensors within the array during scene imaging. If the rate at which photons are striking the sensor varies, then the brightness of the image which the sensor is viewing must be changing. When a circuit built in to the sensor array detects that the image brightness is changing, the amount of charge collected is preserved and the time at which brightness change wag detected is recorded. Each pixel corresponding to each sensor where exposure was stopped is adjusted to the proper exposure by linearly extrapolating the exposure the sensor did receive so that the pixel corresponding to the sensor has an intensity corresponding to the dynamic range of the entire image. The image sensing array will preferably be implemented as active-pixel sensor CMOS image sensors.”

US Patent Application No. 20020131773 discloses “a system and method which allows a camera to be pre-positioned at a given location and the field of view adjusted on a picture by picture basis such that the subject of the picture is centered within the field of view and such that the focal length of the camera lens is optimal for the particular picture. Using this system and method a movable sensor would be positioned at the image to be captured and the camera would effectively swivel to align itself with that trigger based upon translation of signals received from that trigger. Additionally, information obtained from the movable trigger may be used to adjust its field of view via optical and/or digital zoom.”

However, none of the above-cited patents disclose or suggest the use of a motion tracking algorithm for use with a digital video camera employing zoom features. Accordingly, it is an objective of the present invention to provide for a digital video camera that employs a motion detection algorithm to keep the camera locked onto a scene when recording video images and in particular when using digital zoom features of the camera.

### SUMMARY OF THE INVENTION

To accomplish the above and other objectives, the present invention provides for an improved digital video camera having motion detection circuitry that allows the camera to lock onto an image scene while recording the scene, and particularly when digital zoom features of the camera are employed. When using the present digital video camera, the user is not required to accurately aim the camera during the recording.

The present invention takes advantage of the fact that digital video cameras may use very large image sensors that have a resolution that is large compared to the resolution required to record good quality video. This allows for very effective and usable digital zoom. In accordance with the present invention, a smaller and smaller area of the sensor is sampled at higher and higher zoom factors. This means that when the camera is digitally zoomed, the sensor sees a much wider field of view than just the subject of interest.

The present invention uses the very large field of view of the camera to relieve the user from having to constantly and accurately point the camera. The user frames a subject and starts recording, and the camera locks onto and tracks the subject. The user may thus hold the camera in his or her lap or overhead in a crowd and still get a perfectly framed, steady, and professional result. It is this ability that distinguishes the present invention from the image stabilization techniques sited in the prior art. Those inventions attempt to minimize image motion due to camera shake, but intentionally allow and require the user to continually aim the camera accurately at the subject.

Tracking the subject may be done by using frame-to-frame motion detection algorithms. This technology is well-understood in the industry. Since the motion detection algorithm uses a wider field of view than the sampled video frame, it is particularly robust to subject motion. Alternatively, camera motion may be sensed using orientation sensors, such as gravity, magnetic field, or gyro sensors, for example, to drive the tracking algorithm.

A preferred user interface of the camera presents to the user a “framing rectangle” with a current crop/zoom level superimposed over a wide angle live view in the display. The framing rectangle starts at the center of the image. When the record button is pressed, the frame locks onto the scene. As the camera moves, the framing rectangle moves with the image on the display, staying fixed with respect to the scene.

To further reduce the need for the user to watch the viewfinder, an alarm may be provided that warns the user when the camera is near the limits of the field of view.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIG. 1 is a rear view of an exemplary embodiment of a digital video camera in accordance with the principles of the present invention;

FIG. 2 is a front view of the exemplary digital camera;

FIG. 3 is a top view of the exemplary digital camera;

FIG. 4 is a bottom view of the exemplary digital camera; and

FIG. 5 is a flow diagram that illustrates an exemplary method in accordance with the principles of the present invention.

### DETAILED DESCRIPTION

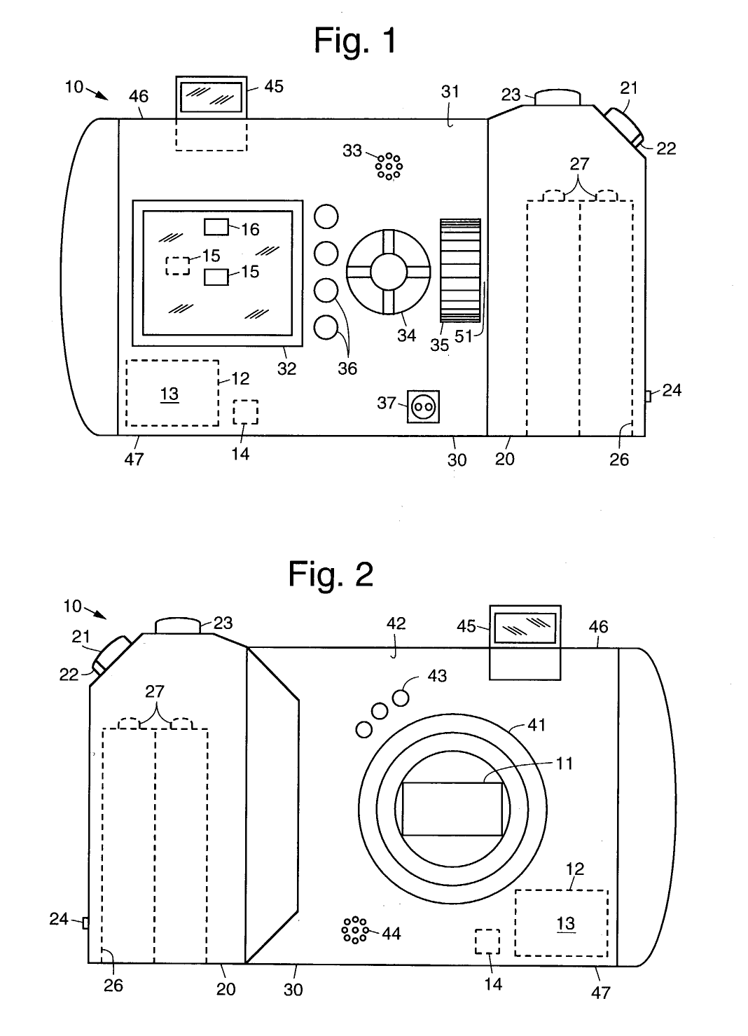

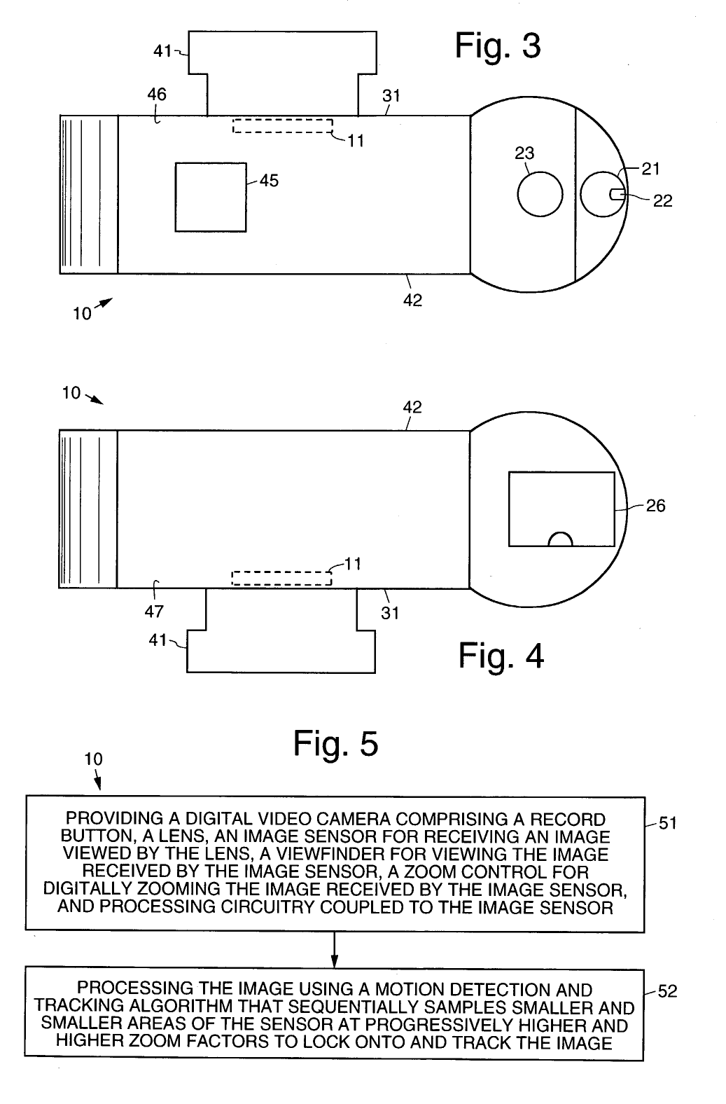

Referring to the sole drawing figures, FIG. 1 is a rear view of an exemplary embodiment of a digital video camera 10 in accordance with the principles of the present invention. FIGS. 2-4 show front, top and bottom views, respectively, of the exemplary digital camera 10.

As is shown in FIGS. 1 and 2, for example, the exemplary digital video camera 10 comprises a handgrip section 20 and a body section 30. The handgrip section 20 includes a power button 21 having a lock latch 22, a record button 23, a strap connection 24, and a battery compartment 26 for housing batteries 27.

As is shown in FIG. 1, a rear surface 31 of the body section 30 comprises a liquid crystal display (LCD) 32 or viewfinder 32, a rear microphone 33, a joystick pad 34, a zoom control dial 35, a plurality of buttons 36 for setting functions of the camera 10 and an output port 37 for downloading images to a computer, for example.

As is shown in FIG. 2, a lens 41 extends from a front surface 42 of the digital video camera 10. A metering element 43 and front microphone 44 are disposed on the front surface 42 of the digital video camera 10.

An image sensor 11 is coupled to processing circuitry 12 (illustrated using dashed lines) are housed within the body section 30. The processing circuitry 12 comprises a motion detection or tracking algorithm 13 that is used to track a subject in an image, lock onto the subject and provide a stable image of the subject. The motion detection algorithm 13 may employ a frame-to-frame motion detection algorithm 13 or a orientation sensor motion detection algorithm 13.

The resolution of the image sensor 11 used in the digital video camera 10 is very large compared to the resolution required to record good quality video. This allows for very effective and usable digital zoom.

The motion detection algorithm 13 employed in the digital video camera 10 samples a smaller and smaller area of the sensor at progressively higher and higher zoom factors. This means that when the camera 10 is digitally zoomed, the image sensor 11 see a much wider field of view than just the subject of interest.

The present invention uses the very large field of view of the image sensor 11 to relieve the user from having to constantly and accurately point the digital video. The user frames a subject and starts recording, and the motion detection algorithm 13 and processing circuitry 12 locks onto and tracks the subject in the viewed image. The user may thus hold the digital video in his or her lap or overhead in a crowd and still get a perfectly framed, steady, and professional result.

Tracking the subject may be done by using frame-to-frame motion detection algorithms 13. Since the motion detection algorithm 13 uses a wider field of view than the sampled video frame, it is particularly robust to subject motion.

Frame-to-frame motion detection algorithms 13 are well-understood in the industry. An exemplary frame-to-frame motion detection algorithm 13 is described as follows: The first frame captured when the user starts the recording is saved as the reference frame. Subsequent frames are compared against this reference frame, using a difference metric such as the sum-of-absolute-differences over all of the pixels in the frame. This metric is computed for different displacements of the frame with respect to the reference frame. The displacement that generates the lowest difference metric indicates the frame-to-frame motion. It is possible to simplify the algorithm in many ways, such as by using a downsampled version of the image data, by searching only a small “neighborhood” of displacements, by only calculating the displacement metric over one or more subsets of the image, and so forth.

Technology for frame-to-frame motion estimation has been developed in conjunction with the MPEG (Motion Picture Experts Group) video compression standard. While some algorithms are proprietary, others have been described publicly in technical journals.

Alternatively, motion of the digital video may be sensed using orientation sensors 14, such as a gravity sensor 14, a magnetic field sensor 14, or a gyro sensor 14, for example, to provide inputs to drive the motion detection algorithm 13. Note that the vibration or acceleration sensors used in the sited image stabilization techniques are note particularly well suited for this invention. The electronic integration required to derive absolute camera motion will undoubtedly cause the resulting image to drift over time, rater than stay on the scene.

A preferred user interface of the camera 10 presents to the user a framing rectangle 15 with a current crop/zoom level 16 superimposed over a wide angle live view in the viewfinder or display 32. The framing rectangle 15 starts at the center of the image. When the record button 23 is pressed, the framing rectangle 15 locks onto the image scene. As the digital video camera 10 moves (illustrated by dashed lines), the framing rectangle 15 moves with the image on the display, staying fixed with respect to the image scene.

To further reduce the need for the user to watch the viewfinder 32 or display 32, an alarm 17 may be provided that warns the user when the digital video camera 10 is near the limits of its field of view.

Referring now to FIG. 5, it is a flow diagram that illustrates an exemplary method 50 in accordance with the principles of the present invention.

The exemplary method 50 keeps a digital video camera locked onto a scene when recording a video image using digital zoom. The exemplary method 40 comprises the following steps.

A digital video camera is provided 51 that comprises a record button, a lens, an image sensor for receiving an image viewed by the lens, a viewfinder for viewing the image received by the image sensor, a zoom control for digitally zooming the image received by the image sensor, and processing circuitry coupled to the image sensor. The image is processed 52 using a motion detection and tracking algorithm that extracts video frames from the sensor images, such that the resulting video image substantially tracks the scene, despite motion of the camera.

Thus, a digital video camera and method have been disclosed that employs a motion detection algorithm to keep the camera locked onto a scene when recording video images, particularly when using digital zoom features of the camera. While the invention describes a digital video camera, it equally describes any digital camera or image capture device which has video recording capability. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Apparatus comprising:
a record button;
a lens;
an image sensor for receiving a series of images viewed by the lens that have a resolution that is higher than the resolution required to record a good quality video image; and
a zoom control for digitally zooming the images received by the image sensor;
processing circuitry coupled to the image sensor that comprises a motion detection and tracking algorithm that extracts video frames from the sensor images, such that the resulting video image substantially tracks the scene, despite motion of the apparatus.

2. The apparatus recited in claim 1 wherein the motion detection algorithm comprises a frame-to-frame motion detection algorithm.

3. The apparatus recited in claim 1 wherein the motion detection algorithm comprises an orientation sensor motion detection algorithm.

4. The apparatus recited in claim 1 further comprising a orientation sensor coupled to the processing circuitry that provides inputs to drive the motion detection algorithm.

5. The apparatus recited in claim 4 wherein the orientation sensor includes a gravity sensor.

6. The apparatus recited in claim 4 wherein the orientation sensor comprises a magnetic field sensor.

7. The apparatus recited in claim 4 wherein the orientation sensor comprises a gyro sensor.

8. The apparatus recited in claim 1 further comprising an electronic viewfinder, displaying a user interface that comprises a framing rectangle with a current crop/zoom level superimposed over a wide angle view in the viewfinder, which framing rectangle is initially located at the center of the image, and when the record button is pressed, the framing rectangle locks onto the image scene, and as the apparatus moves, the framing rectangle moves with the image displayed on the viewfinder, staying fixed with respect to the image scene.

9. The apparatus recited in claim 8 further comprising an alarm that warns a user that the digital video camera is near the limits of its field of view.

10. A method that keeps an apparatus locked onto a scene when recording a video image using digital zoom, comprising the steps of:
providing apparatus comprising a record button, a lens, an image sensor for receiving an image viewed by the lens, received by the image sensor, a zoom control for digitally zooming the image received by the image sensor, and processing circuitry coupled to the image sensor; and
processing the image using a motion detection and tracking algorithm that extracts video frames from the sensor images, such that the resulting video image substantially tracks the scene, despite motion of the apparatus.

11. The method recited in claim 10 wherein the motion detection algorithm comprises a frame-to-frame motion detection algorithm.

12. The method recited in claim 10 wherein the motion detection algorithm comprises a orientation sensor motion detection algorithm.

13. The method recited in claim 10 wherein the apparatus further comprises a orientation sensor coupled to the processing circuitry that provides inputs to the motion detection algorithm.

14. The method recited in claim 13 wherein the orientation sensor comprises a gravity sensor.

15. The method recited in claim 13 wherein the orientation sensor comprises a magnetic field sensor.

16. The method recited in claim 13 wherein the orientation sensor comprises a gyro sensor.

17. The method recited in claim 11 wherein the apparatus further comprises a user interface having a framing rectangle with a current crop/zoom level superimposed over a wide angle view in the viewfinder, and wherein the method further comprises the steps of:
initially locating the framing rectangle at the center of the image;
pressing the record button;
locking the framing rectangle onto the image scene; and
causing the framing rectangle to move with the image displayed on the viewfinder, which stays fixed with respect to the image scene.

18. The method recited in claim 11 further comprising the step of:
providing an alarm that warns a user when the apparatus is near the limits of its field of view.
